(19) United States
(12) Patent Application Publication
(10) Pub. No.: US 2006/0200913 A1
(43) Pub. Date: Sep. 14, 2006

(54) Plier handle

(76) Inventor: Jiaman Guan, Yangjiang City (CN)

Correspondence Address: Mr. Eric Chan, 42 Pin Oaks Drive, Phoenixville, PA, 19460, US

(21) Appl. No.: 11/128,278

(22) Filed: May 13, 2005

(30) Foreign Application Priority Data
Mar. 9, 2005 (CN) 200520055373.5

(51) Int. Cl. B25B 7/22

(52) U.S. Cl. 7/128; 81/427.5

(57) ABSTRACT

The present invention relates to a plier handle comprising a body member with two sides connected by a connecting member, and a through hole for fixing one end of a plier grip disposed near the front end on each of the two sides of the body member, wherein the rear end of the body member is pivotally connected to various knife blades, and each of the knife blades has a locking member; a control plate is disposed in between the two sides, and one end of the control plate engages with the locking member of a knife blade and the other end engages with the end of the plier grip. The knife blades are easier to be pulled out or folded up and are prevented from turning over. The plier grip is fixed in vertical position corresponding to the plier handle. It has a compact structure fulfilling various daily needs.

### BACKGROUND OF THE INVENTION

The present invention relates generally to parts for hand tools and more particularly pertains to a handle for pliers.

The available pliers in the marketplace usually possess plier handles of U shape or rod shape which are manufactured by means of single die-casting to form integrally with the pliers in one piece. The processing costs are high and they usually serve only one function not for other purposes. Configurations for plier handles with knife blades pivotally connected to the rear ends thereof have existed in the art, but the knife blades are not easily fixed in position while in use and they turns over easily, making it difficult for users to exert force. Moreover, since the plier handles are integrally formed with the pliers by single die-casting, elasticity required cannot be applied onto the knife blades. When in use, the knife blades cannot be easily pulled out from the plier handles or folded up and placed inside the plier handles. This lowers the value of the product and brings inconvenience to users.

### BRIEF SUMMARY OF THE INVENTION

In view of the aforesaid disadvantages now present in the prior art, the present invention provides a new plier handle which is multi-functional, at low production cost and convenient to use.

To attain this, the present invention generally comprises a body member with two sides which are connected by a connecting member, and a through hole for fixing a plier grip is disposed near the front end on each of the two sides of the body member, wherein the rear end of the body member is pivotally connected to various knife blades through pivots, and each of the knife blades has a locking member; a control plate is disposed in between the two sides of the body member, and one end of the control plate engages with the locking members of knife blades and the other end engages with the end of the plier grip.

As an improvement in the present invention, the control plate is of an arc shape, and has integrally formed lugs on its two sides, and the control plate is made of elastic material.

The knife blades comprises one or more kinds of tool blades.

The connecting member is of U shape, and the two sides of the U shape are fixed onto the body member. As a further improvement in the present invention, the front end of the connecting member has a spring piece which engages with the plier grip on the inner side, and the spring piece is separated from the two sides of the connecting member. A slot is disposed in the position where the spring piece is connected to the connecting member.

It is an object of the present invention to provide a new plier handle which is multi-functional and convenient to use. A control plate of good elasticity is disposed in the lower part of the plier handle, and the control plate is separately formed and made of elastic material, one end of which engages with the knife blade which is pivotally connected to the rear end of the plier handle, thus making the knife blade easier to be pulled out or folded up and preventing the knife blade from turning over while in use. The other end of the control plate engages with the plier grip and fixes the plier grip in position corresponding to the plier handle. The rear end of the plier handle is pivotally connected to various knife blades, thereby making the plier handle to possess more functions. The spring piece at the front end of the connecting member engages with the plier grip on the inner side, resulting in improved contact between the two.

It is another object of the present invention to provide a new plier handle which is at low production cost. As the plier handle is configured by splitting into parts and the parts are connected together by rivets or welding, this reduces the cost of single die-casting.

It is a further object of the present invention to provide a new plier handle which has a compact structure fulfilling various daily needs and is convenient for household use, economical and convenient for storage and carry, thus overcoming the disadvantages of the prior art.

Further objects and advantages of the present invention will become more apparent from the following description and explanation with reference to the accompanying drawings.

### BRIEF DESCRIPTION OF THE DRAWINGS

FIG. 1 shows the perspective view of a plier handle of the present invention.

FIG. 2 shows the perspective view of the connecting member as shown in FIG. 1.

FIG. 3 shows the perspective view of the control plate as shown in FIG. 1.

FIG. 4 shows the elevational view of a pair of plier handles after being assembled with a plier.

FIG. 5 shows the cross-sectional view of the pair of plier handles with the plier.

### DETAILED DESCRIPTION OF THE INVENTION

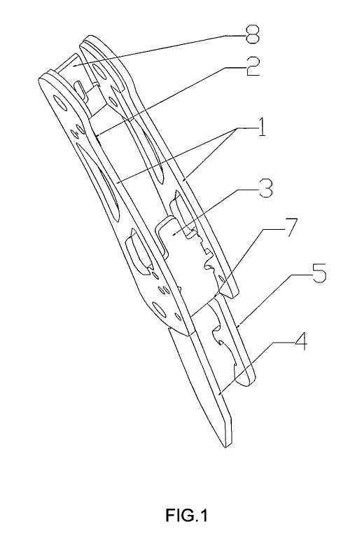

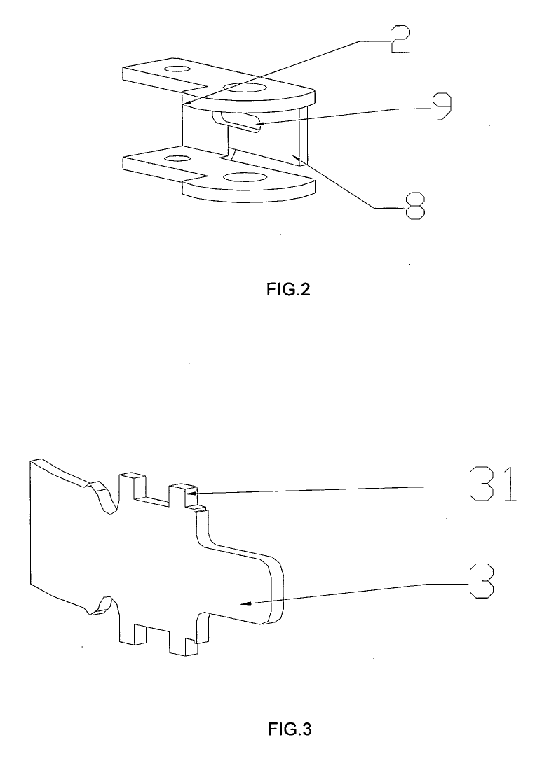

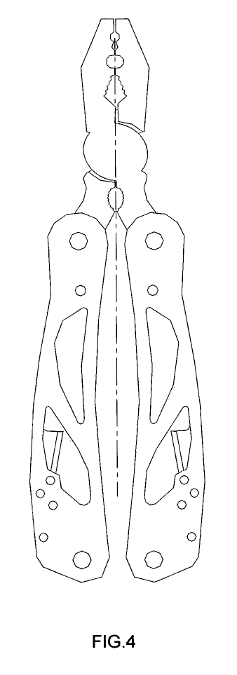

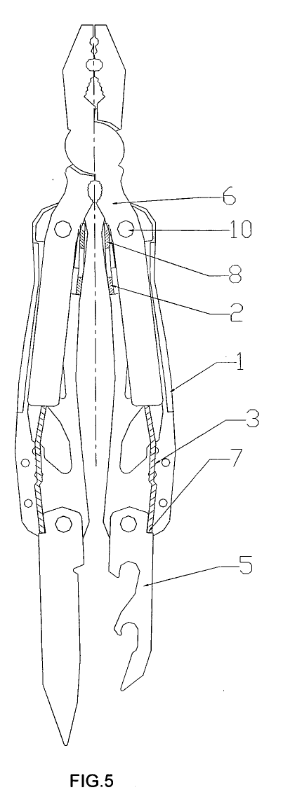

As illustrated in FIGS. 1, 3 and 4, the front ends of the two symmetric sides of the body member 1 of the present invention are connected with each other by a U-shaped connecting member 2. A cutting knife blade 4 and a bottle opener 5 are pivotally connected respectively to the rear ends of the two sides of the body member 1 by pivots. Various kinds of tool knife blades such as a slot-type screwdriver, a Philip-type screwdriver, a file, a saw blade and so forth can be connected. A locking member 7 is disposed on each of these knife blades to avoid the knife blades from turning over. On the side to which the knife blades are pivotally connected, there is an arc-shaped control plate 3 disposed in between the body member 1. Lugs 31 which are integrally formed on the two sides of the control plate 3 insert into the corresponding holes on the body member 1. As shown in FIGS. 3 and 5, the control plate 3 is made of elastic material by means of single die-casting, with one end engages with the locking members 7 of the knife blades, and the other end fixes the plier grip 6 in position. The elastic control plate 3 engages with the locking members 7 and since the control plate 3 has good elasticity, the knife blades are easier to be pulled out or folded up and are prevented from turning over while in use. The other end of the elastic control plate 3 engages with the plier grip 6 and fixes the plier grip in vertical position corresponding to the plier handle. As illustrated in FIGS. 2 and 5, the front end of the U-shaped connecting member 2 has a spring piece 8 which is separated from the two sides of the connecting member 2. The spring piece 8 forms integrally with the connecting member 2 in one piece. A slot 9 is disposed in the position where the spring piece 8 is connected to the connecting member 2 to increase elasticity. The spring piece 8 can also be a separate part from the connecting member 2, and may be fixed together by rivets or welding, and in such a case, the spring piece 8 is made of elastic material. The spring piece 8 at the front end of the connecting member 2 engages with the plier grip 6 on the inner side, resulting in improved contact between the two. As the plier handle is configured by splitting into parts and the parts are connected together by rivets or welding, in comparison with the prior art, this reduces the cost of single die-casting and allows the control plate 3 to have better elasticity. It has a compact structure fulfilling various daily needs and is convenient for household use, economical and convenient for storage and carry. In practical use, knife blades that are pivotally connected to the rear end of the plier handle are not limited to the abovementioned knife blades. Various different knife blades can be connected to fulfill different needs.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A plier handle comprising a body member with two sides which are connected by a connecting member, and a through hole for fixing a plier grip is disposed near the front end on each of the two sides of the body member, wherein the rear end of the body member is pivotally connected to various knife blades through pivots, and each of the knife blades has a locking member; a control plate is disposed in between the two sides of the body member, and one end of the control plate engages with the locking members of knife blades and the other end engages with the end of the plier grip.

2. The plier handle as in claim 1, wherein the control plate is made of elastic material.

3. The plier handle as in claim 2, wherein the control plate is of an arc shape, and has integrally formed lugs on its two sides.

4. The plier handle as in claim 3, wherein knife blades comprises one or more kinds of tool blades.

5. The plier handle as in any one of claims 1 to 4, wherein the connecting member is of U shape, and the two sides of the U shape are fixed onto the body member.

6. The plier handle as in claim 5, wherein the front end of the connecting member has a spring piece which engages with the plier grip on the inner side, and the spring piece is separated from the two sides of the connecting member.

7. The plier handle as in claim 6, wherein a slot is disposed in the position where the spring piece is connected to the connecting member.
